(19) United States
(12) Patent Application Publication
(10) Pub. No.: US 2019/0120598 A1
(43) Pub. Date: Apr. 25, 2019

(54) BALLISTIC STRIKE PLATE

(71) Applicant: BOURQUE INDUSTRIES, INC., Tempe, AZ (US)

(72) Inventors: Cole A. Bourque, Tucson, AZ (US); John M. Bourque, Tempe, AZ (US)

(21) Appl. No.: 16/204,002

(22) Filed: Nov. 29, 2018

Related U.S. Application Data
(63) Continuation of application No. PCT/US2017/035632, filed on Jun. 2, 2017.
(60) Provisional application No. 62/344,474, filed on Jun. 2, 2016.

(51) Int. Cl. F41H 5/04; B32B 5/26

(52) U.S. Cl. CPC F41H 5/0471; B32B 2571/02; B32B 2262/0253; B32B 5/26

(57) ABSTRACT

In a body armor assembly and method of forming the body armor assembly a strike plate is provided that is formed of a number of sheets layered on each other. Each sheet of the strike plate is formed of fibers having a parallel orientation greater than 70%. The sheets are oriented such that the parallel-oriented fibers of all of the plural sheets are oriented or aligned in a single direction. The body armor assembly includes a backing plate formed of a metal or a metal alloy with randomly oriented atoms, or fibers that have a random orientation. The backing plate and the strike plate are joined, or bonded, or cross-linked together. Each strike plate sheet can be formed of ultra-high-molecular-weight polyethylene (UHMWPE) fibers. The backing plate can be formed of polyethylene thermoplastic fibers.

### CROSS REFERENCE TO RELATED APPLICATION

This application is a continuation of International Application Number PCT/US2017/035632, filed Jun. 2, 2017, and claims priority to U.S. Provisional Patent Application No. 62/344,474, filed Jun. 2, 2016, the contents of which are incorporated in their entirety herein by reference.

### BACKGROUND OF THE INVENTION

### Field of the Invention

The present invention relates to ballistic strike plates, especially body armor plates and other protective ballistic strike plates, assemblies of ballistic strike plates including odly armor plates and other protective ballistic strike plates, as well as methods for making these products.

### Description of Related Art

Body armor and other protective armor for similar applications is usually formed from a series of plates each comprising a plurality of layers of different materials. Materials such as alloyed ceramics have been successfully employed in body armor plates. In addition, metal plates, formed from, for example, titanium, have been employed in ballistic strike plates and ballistic strike plate assemblies. U.S. Pat. Nos. 6,285,192 and 8,375,840 disclose multi-layer ballistic strike plate assemblies.

### SUMMARY OF THE INVENTION

Various preferred and non-limiting examples of the present invention will now be described and set forth in the following numbered clauses:

Clause 1: A body armor assembly comprises: a body armor plate; and a wrap over an exterior of the body armor plate, wherein the body armor plate comprises: a strike plate formed of plural sheets layered on each other, each sheet of the strike plate formed of fibers having a parallel orientation greater than 70%, the plural sheets oriented such that the parallel-oriented fibers of all of the plural sheets are oriented or aligned in a single direction; and a backing plate formed of a metal, or a metal alloy, or fibers that have a random orientation, wherein the backing plate and the strike plate are joined, bonded, or cross-linked together.

Clause 2: The body armor assembly of clause 1, wherein each strike plate sheet can be formed of thermoplastic polyethylene fibers. In an example, the thermoplastic polyethylene fibers can comprise ultra-high-molecular-weight polyethylene (UHMWPE) fibers.

Clause 3: The body armor assembly of clause 1 or 2, wherein the backing plate can be formed of polyethylene thermoplastic fibers.

Clause 4: The body armor assembly of any one of clauses 1-3, wherein the polyethylene thermoplastic fibers can comprise high-density polyethylene (HDPE) or polyethylene high-density (PEHD).

Clause 5: The body armor assembly of any one of clauses 1-4, wherein the wrap can comprise one or more thermoplastic polyethylene fiber sheets, e.g., one or more ultra-high-molecular-weight polyethylene (UHMWPE) fiber sheets, with each sheet of the warp formed of fibers having a parallel orientation greater than 70%.

Clause 6: The body armor assembly of any one of clauses 1-5, wherein the parallel-oriented fibers of the one or more sheets forming the warp can be oriented transverse to the parallel-oriented fibers of the strike plate sheets.

Clause 7: The body armor assembly of any one of clauses 1-6, wherein: the wrap can be placed on a side of the backing plate facing away from the strike plate; the warp can be wrapped over sides of the backing plate and strike plate; and edges of the wrap can terminate on a side of the strike plate facing away from the backing plate.

Clause 8: The body armor assembly of any one of clauses 1-7 can further include a cover sheet covering the edges of the warp.

Clause 9: The body armor assembly of any one of clauses 1-8, wherein the cover sheet can be formed of fibers having a parallel orientation greater than 70%.

Clause 10: A body armor plate comprises a strike plate formed of plural sheets layered on each other, each sheet of the strike plate is formed of fibers having a parallel orientation greater than 70%. The plural sheets can be oriented such that the parallel-oriented fibers of all of the plural sheets are oriented or aligned in a single direction. The body armor plate can further comprise a backing plate formed of a metal, or a metal alloy, or fibers that have a random orientation. The backing plate and the strike plate are joined or bonded or cross-linked together.

Clause 11: The body armor plate of clause 10, wherein each strike plate sheet can be formed of thermoplastic polyethylene fibers. In an example, the thermoplastic polyethylene fibers can comprise ultra-high-molecular-weight polyethylene (UHMWPE) fibers.

Clause 12: The body armor plate of clause 10 or 11, wherein the backing plate can be formed of polyethylene thermoplastic fibers.

Clause 13: The body armor plate of any one of clauses 1-12, wherein the polyethylene thermoplastic fibers can comprise high-density polyethylene (HDPE) or polyethylene high-density (PEHD).

Clause 14: A method of forming a body armor assembly comprises: (a) providing a strike plate formed of plural sheets layered on each other, each sheet of the strike plate formed of fibers having a parallel orientation greater than 70%, the plural sheets oriented such that the parallel-oriented fibers of all of the plural sheets are oriented or aligned in a single direction; (b) providing a backing plate formed of a metal, or a metal alloy, or fibers that have a random orientation; and (c) joining or, bonding or, cross-linking the backing plate and the strike plate together.

Clause 15: The method of clause 14, wherein step (a) can includes bonding or cross-linking the plural sheets of the strike plate together using heat and pressure.

Clause 16: The method of clause 14 or 15, wherein step (c) can includes bonding or cross-linking the backing plate and the strike plate together using heat and pressure.

Clause 17: The method of any one of clauses 14-16 can further include: (d), following step (c), wrapping the backing plate and the strike plate with a warp.

Clause 18: The method of any one of clauses 14-17, wherein step (d) can include bonding or cross-linking the wrap to the backing plate, the strike plate, or both using heat and pressure.

Clause 19: The method of any one of clauses 14-17, wherein at least one of the following: the strike plate sheets of thermoplastic polyethylene fibers. In an example, the thermoplastic polyethylene fibers can comprise ultra-high-molecular-weight polyethylene (UHMWPE) fibers. The backing plate can be formed of high-density polyethylene (HDPE) or polyethylene high-density (PEHD) material. Finally, the warp can be formed of UHMWPE.

### BRIEF DESCRIPTION OF THE DRAWINGS

FIG. 1 is a perspective view of a single sheet of ultra-high-molecular-weight polyethylene (UHMWPE) fibers, with the fibers of the single sheet all aligned uni-directionally, i.e., in a single direction;

FIG. 2 is a perspective view of a ballistic strike plate comprised of a number of the UHMWPE fiber sheets of FIG. 1, with the fibers of all of the sheets aligned uni-directionally, i.e., in a single direction;

FIG. 3 is a perspective view of a backing plate comprised of a metal, or a metal alloy, or high-density polyethylene (HDPE) or polyethylene high-density (PEHD) with the polymer chains of the HDPE or PEHD randomly oriented; and

FIG. 4. is a perspective view of a larger area single sheet of UHMWPE fibers of the type shown in FIG. 1 shown being diaper wrapped around the ballistic strike plate of FIG. 2 positioned atop of the backing plate of FIG. 3 from the backside of the backing plate, with the fibers of the larger area single sheet optionally oriented transverse to the direction of the fibers of the ballistic strike plate, and with an optional fiber cover sheet, optionally made from a sheet or sheets of UHMWPE fibers, shown being placed on the front side of the ballistic strike plate over the exposed edges of the diaper wrapped larger area single sheet.

### DESCRIPTION OF THE INVENTION

Various non-limiting examples will now be described with reference to the accompanying figures where like reference numbers correspond to like or functionally equivalent elements.

For purposes of the description hereinafter, the terms “end,” “upper,” “lower,” “right,” “left,” “vertical,” “horizontal,” “top,” “bottom,” “lateral,” “longitudinal,” and derivatives thereof shall relate to the example(s) as oriented in the drawing figures. However, it is to be understood that the example(s) may assume various alternative variations and step sequences, except where expressly specified to the contrary. It is also to be understood that the specific example(s) illustrated in the attached drawings, and described in the following specification, are simply exemplary examples or aspects of the invention. Hence, the specific examples or aspects disclosed herein are not to be construed as limiting.

Briefly, ultra-high-molecular-weight polyethylene (UHMWPE) is a subset of thermoplastic polyethylene. UHMWPE has extremely long chains (defining fibers) of polyethylene, which preferentially align in parallel in the same direction. UHMWPE has a molecular mass generally between 3.5 and 7.5 million amu and is considered a tough material, with the highest impact strength of any thermoplastic presently made. In an example, UHMWPE can have strength-to-weight ratio of 8 to 15 times higher than steel.

When formed into fiber sheet(s), UHMWPE polymer chains can, in an example, attain a parallel orientation greater than 70%, 80%, 90% or 95%, and a level of crystallinity from 39% to 75%. UHMWPE can have a melting point around 290°−305° F. (143° C.-152° C.).

Fiber sheets of UHMWPE are commercially available under the trademark Dyneema® from Koninklijke DSM N.V., the Netherlands. In the U.S., Dyneema® is a registered trademark of DSM IP Assets B.V. Limited Liability Company Netherlands Heerlen Netherlands.

In a non-limiting example, thermoplastic polyethylene, in particular UHMWPE can have the following structure, where n is greater than 100,000. However, this is not be construed in a limiting sense since the use of thermoplastic polyethylene having a different structure, but having the same efficacy for the uses described herein, is envisioned.

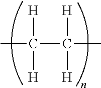

For purpose of describing the examples, specific reference may be made to fiber sheet(s) made from UHMWPE. However, this is not be construed in a limiting sense since it is envisioned that fiber sheet(s) made from any suitable and/or desirable thermoplastic polyethylene having the same efficacy for the uses described herein can be used in place of fiber sheet(s) made from UHMWPE.

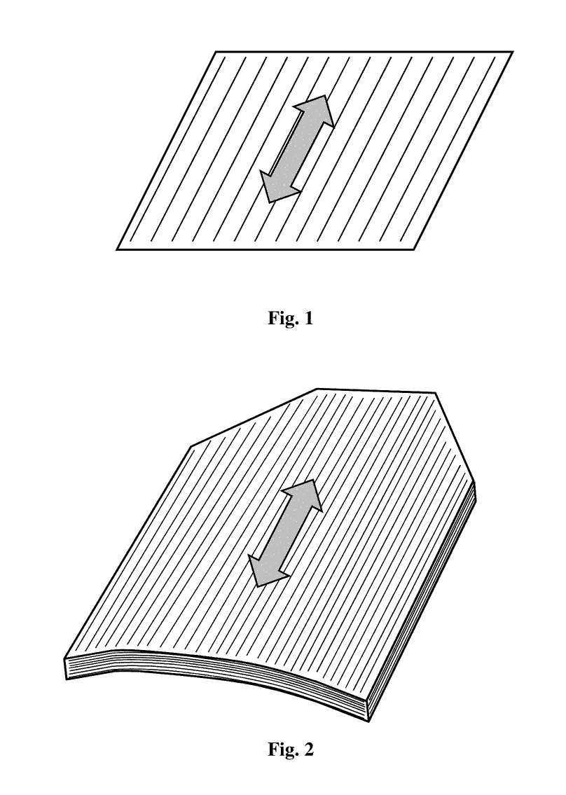

Referring to FIG. 1, a UHMWPE fiber sheet 2 that can be used, for example, for ballistic protection can be manufactured from UHMWPE fibers oriented or aligned uni-directionally, i.e., in a single direction, as shown by two-headed arrow 4 in FIG. 1.

UHMWPE fibers are highly cross-linked structures, (bonds across linked chains of individual polymer fibers). UHMWPE fibers are lightweight with elongated, high-strength, parallel-oriented strands. The uni-directional orientation (FIG. 1) of the UHMWPE fibers forming UHMWPE fiber sheet 2 provides high energy absorption with separating the interlock-fibers (cross-link) strands across multiple bonded layers forming a composite structure in the nature of UHMWPE fiber sheet 2.

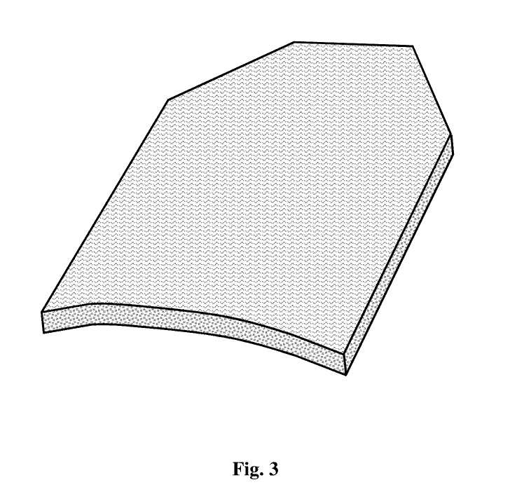

With reference to FIG. 2 and with continuing reference to FIG. 1, in an example, multiple or plural layers of UHMWPE fiber sheets 2 can be layered on each other and can be bonded together, with the parallel-oriented fibers of all of the UHMWPE fiber sheets 2 oriented or aligned uni-directionally, i.e., in a single direction (as shown by two-headed arrow 8 in FIG. 2), to form a fiber plate 6 made from the multiple or plural layers of UHMWPE fiber sheets 2.

More specifically, the multiple or plural layers of UHMWPE fiber sheets 2 forming fiber plate 6 can be layered together (one atop of the other) with their facing surfaces in contact or joined, bonded, or cross-linked together to form fiber plate 6 which can be used as a strike plate in a body armor assembly. In an example, all of the UHMWPE fiber sheets 2 have their parallel-oriented fibers oriented in the same direction, e.g., vertically (FIG. 2). However, this is not be construed in a limiting sense since it is envisioned that all of the UHMWPE fiber sheets 2 forming fiber plate 6 can have their parallel-oriented fibers oriented in any suitable and/or desirable direction, e.g., horizontally or laterally.

Bonding or joining together of the individual UHMWPE fiber sheets 2 together to form fiber plate 6 can be accomplished by using a combination of heat and pressure for joining the fibers of adjacent UHMWPE fiber sheets 2 at an interface between the surfaces of the adjacent UHMWPE fiber sheets 2 that can be in contact with each other. Using a temperature slightly under the melting point of the fibers (290° F.-305° F.; 143° C.-151° C.) in combination with a pressure induces cross-linking of the parallel-oriented fibers of UHMWPE fiber sheets 2. In an example, the pressure used to induce cross-linking of the parallel-oriented fibers of facing UHMWPE fiber sheets 2, can be between 5-100 tons/in² (77-1545 newtons/mm²), or between 5-60 tons/in² (77-927 newtons/mm²), or between 5-30 tons/in² (77-463 newtons/mm²). However, this is not to be construed in a limiting sense since it is envisioned that any suitable and/or desirable pressure that facilitates cross-linking of the parallel-oriented fibers of UHMWPE fiber sheets 2 can be used. Optionally, an external adhesive or solvent can be also be used alone or in combination with cross-linking to join or bond the fibers of adjacent UHMWPE fiber sheets 2 together to form fiber plate 6 that can be used as a strike plate in body armor.

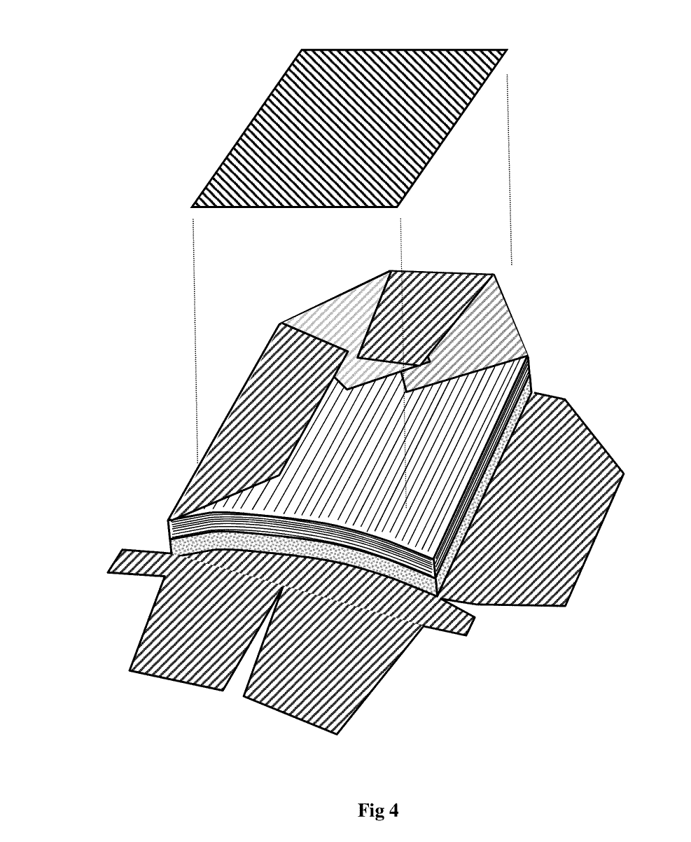

With reference to FIG. 3, a backing plate 8 joined, bonded, or cross-linked to the fiber plate 6 used in a body armor assembly can, in an example, be made from a metal, or a metal alloy, or polyethylene thermoplastic, such as, for example, high-density polyethylene (HDPE) or polyethylene high-density (PEHD).

The physical properties of polyethylene thermoplastic used to form the backing plate can vary depending on the molding process that is used to manufacture a specific sample. The backing plate 8 can be cut and formed from commercial sheet stock of HDPE or PEHD, or molded directly from polymers to a net shape for the design of backing plate 8. The polyethylene thermoplastic used to form the backing plate is similar to UHMWPE fiber sheets 2 except that the polymer chains of the polyethylene thermoplastic used to form the backing plate do not have any fiber orientation, i.e., random orientation.

With reference to FIG. 4, the metal, or metal alloy, or polymer chains of the polyethylene thermoplastic forming backing plate 8 can be bonded, or joined, or cross-linked to fiber plate 6. In an example, the polymer chains of backing plate 8 formed of polyethylene thermoplastic can be cross-linked with the polymer chains of the UHMWPE fiber sheets 2 using heat and pressure. In an example, facing surfaces of fiber plate 6 and backing plate 8 formed from polyethylene thermoplastic can be cross-linked together using the temperature(s) and pressure(s) described above for joining multiple UHMWPE fiber sheets 2 together. Also or alternatively, external adhesive and/or solvent can be used to join or bond the facing surfaces of fiber plate 6 and backing plate 8 (made from metal, or metal alloy, or polyethylene thermoplastic) together to form body armor plate 10.

In use of body armor plate 10, fiber plate 6 is the strike plate that, in use, is positioned away from a user (facing an incoming projectile) and body armor plate 10 is positioned between fiber plate 6 and the user. e.g., in contact, with the user.

The random orientation of the atoms of the metal or metal alloy, or the random orientation of the polymer chains of the polyethylene thermoplastic forming backing plate 8 in combination with the polymer chains of the UHMWPE fiber sheets 2 forming fiber plate 6 all aligned uni-directionally, i.e., in a single direction provides an improved body armor plate over traditional body armor plates.

In an example, the highest strengths in the UHMWPE fiber sheets 2 are along the primary chain direction of the polymer fibers.

In an example in connection with body armor plate 10, as a projectile enters a surface of fiber plate 6 (formed of UHMWPE fiber sheets 2 having the fibers of all of the sheets aligned uni-directionally, i.e., in a single direction) facing away from backing plate 8, the joining or bonding of the metal or metal alloy or polyethylene thermoplastic of backing plate 8 to the fiber plate 6, or the cross-linking between the fibers of the UHMWPE fiber sheets 2 forming fiber plate 6 to the backing plate 8 formed from polyethylene thermoplastic will slow the velocity of the projectile. The random orientation of atoms or polymer chains in backing plate 8, in-turn, provide a stopping point limiting the give or deformation of fiber plate 6.

The physical properties of fiber plate 6 formed of UHMWPE fiber sheets 2, having the fibers of all of the sheets 2 aligned uni-directionally, i.e., in a single direction, joined, bonded, or cross-linked to backing plate 8 having randomly oriented atoms or polymer fibers reduces or eliminates the physical transition between fiber plate 6 and backing plate 8. Reducing or eliminating this physical transition avoids delamination of fiber plate 6 (acting as a striker plate) and backing plate 8. In an example, body armor 10 formed of fiber plate 6, acting as strike plate, atop of backing plate 8 (FIG. 4) will deflect a projectile with little or no shearing across the transition between fiber plate 6 bonded or joined or cross-linked with backing plate 8.

With continuing reference to FIG. 4, a diaper wrap 12 comprised of one or more UHMWPE fiber sheets 2′ (similar to UHMWPE fiber sheets 2) can be wrapped over the exterior of body armor plate 10. In an example, diaper wrap 12 can be placed on the side of backing plate 8 that faces away from fiber plate 6, i.e., the side of backing plate 8 which, in use, is positioned against the body, and wrapped towards the front side of fiber plate 6, i.e., the side of fiber plate 6 that faces away from backing plate 8.

In an example, the UHMWPE fiber sheet(s) 2′ forming diaper wrap 12 can be placed with the fibers of said UHMWPE fiber sheet(s) 2′ transverse, for example, at an acute angle, to the uni-directionally oriented or aligned fibers of the UHMWPE fiber sheets 2 forming fiber plate 6.

Cuts in the UHMWPE fiber sheet(s) 2′ forming diaper wrap 12 can be minimized by forming and folding tabs of the UHMWPE fiber sheet(s) 2′ around the exterior corners and exterior profile of fiber plate 6 (striker plate of body armor plate 10) providing a containment layer of UHMWPE fibers. A UHMWPE fiber cover sheet 2″ (similar to UHMWPE fiber sheets 2) can be placed on the front side of fiber plate 6 over the exposed edges of diaper wrap 12. The diaper wrap 12 provides one or more protective layers for containing spall from fragmentation of a projectile impacting fiber plate 6.

In an example, heat and pressure, e.g., the temperature(s) and pressure(s) described above for joining multiple UHMWPE fiber sheets 2 together, can be applied to the diaper wrap for bonding diaper wrap 12, fiber plate 6, and, optionally, backing plate 8, when formed of polyethylene thermoplastic, together by cross-linking of the polymer fibers chains together. With the use of shaped molds for the profile of body armor plate 10, the three components can be fully bonded together as a single composite structure to form a body armor assembly 14.

Exterior to diaper wrap 12, a final spall wrap or spray coating can optionally be applied to body armor 14 assembly or body armor plate 10 to provide environmental protection to as required.

As can be seen, disclosed herein is a body armor assembly comprising: a body armor plate; and a wrap over an exterior of the body armor plate, wherein the body armor plate comprises: a strike plate formed of plural sheets layered on each other, each sheet of the strike plate formed of fibers having a parallel orientation greater than 70%, the plural sheets oriented such that the parallel-oriented fibers of all of the plural sheets are oriented or aligned in a single direction; and a backing plate formed of a metal, or a metal alloy, or fibers that have a random orientation, wherein the backing plate and the strike plate are joined, or bonded, or cross-linked together.

Each strike plate sheet can be formed of ultra-high-molecular-weight polyethylene (UHMWPE) fibers. The backing plate can be formed of polyethylene thermoplastic fibers. The polyethylene thermoplastic fibers comprise high-density polyethylene (HDPE) or polyethylene high-density (PEHD).

The wrap can be comprised of one or more ultra-high-molecular-weight polyethylene (UHMWPE) sheets, each sheet of the warp formed of fibers having a parallel orientation greater than 70%.

The parallel-oriented fibers of the one or more sheets forming the warp can be oriented transverse to the parallel-oriented fibers of the strike plate sheets.

The wrap can be placed on a side of the backing plate facing away from the strike plate. The warp can be wrapped over sides of the backing plate and strike plate. Edges of the wrap can terminate on a side of the strike plate facing away from the backing plate.

A cover sheet can cover the edges of the warp. The cover sheet can be formed of fibers having a parallel orientation greater than 70%.

Also disclosed is a body armor plate comprising a strike plate formed of plural sheets layered on each other, each sheet of the strike plate formed of fibers having a parallel orientation greater than 70%, the plural sheets oriented such that the parallel-oriented fibers of all of the plural sheets are oriented or aligned in a single direction; and a backing plate formed of a metal, or a metal alloy, or fibers that have a random orientation, wherein the backing plate and the strike plate are joined, or bonded, or cross-linked together.

Each strike plate sheet can be formed of ultra-high-molecular-weight polyethylene (UHMWPE) fibers. The backing plate can be formed of polyethylene thermoplastic fibers. The polyethylene thermoplastic fibers can comprise high-density polyethylene (HDPE) or polyethylene high-density (PEHD).

Also disclosed herein is a method of forming a body armor assembly comprising: (a) providing a strike plate formed of plural sheets layered on each other, each sheet of the strike plate formed of fibers having a parallel orientation greater than 70%, the plural sheets oriented such that the parallel-oriented fibers of all of the plural sheets are oriented or aligned in a single direction; (b) providing a backing plate formed of a metal, or a metal alloy, or fibers that have a random orientation; and (c) joining, or bonding, or cross-linking the backing plate and the strike plate together.

Step (a) can include bonding the plural sheets of the strike plate together using heat and pressure.

Step (c) can include bonding the backing plate and the strike plate together using heat and pressure.

The method can further include (d), following step (c), wrapping the backing plate and the strike plate with a warp.

Step (d) can include bonding the wrap to the backing plate and the strike plate using heat and pressure.

The strike plate sheets can be formed of ultra-high-molecular-weight polyethylene (UHMWPE). The backing plate can be formed of high-density polyethylene (HDPE) or polyethylene high-density (PEHD) material. The warp can be formed of UHMWPE.

Finally, the term “strike plate” as used herein is not to be construed in a limiting sense since it is envisioned that body armor plate 10 can be used as a backing for another plate made of any suitable and/or desirable material or combination of materials positioned on the side of fiber plate 6 facing away from backing plate 8 for use in body armor designed for stopping high energy and/or high velocity projectiles. Hence, as used herein, the term “strike plate” is not to be construed in a limiting sense.

The foregoing examples have been described with reference to the accompanying figures. Modifications and alterations will occur to others upon reading and understanding the foregoing examples which are provided for the purpose of illustration and are not to be construed in a limiting sense. Accordingly, the foregoing examples are not to be construed as limiting the disclosure.

The invention claimed is:

1. A body armor assembly comprising:
a body armor plate; and
a wrap over an exterior of the body armor plate, wherein the body armor plate comprises:
a strike plate formed of plural sheets layered on each other, each sheet of the strike plate formed of fibers having a parallel orientation greater than 70%, the plural sheets oriented such that the parallel-oriented fibers of all of the plural sheets are oriented or aligned in a single direction; and
a backing plate formed of a metal, or a metal alloy, or fibers that have a random orientation, wherein the backing plate and the strike plate are joined, or bonded, or cross-linked together.

2. The body armor assembly of claim 1, wherein each strike plate sheet is formed of ultra-high-molecular-weight polyethylene (UHMWPE) fibers.

3. The body armor assembly of claim 1, wherein the backing plate is formed of polyethylene thermoplastic fibers.

4. The body armor assembly of claim 3, wherein the polyethylene thermoplastic fibers comprise high-density polyethylene (HDPE) or polyethylene high-density (PEHD).

5. The body armor assembly of claim 1, wherein the wrap is comprised of one or more ultra-high-molecular-weight polyethylene (UHMWPE) sheets, each sheet of the warp formed of fibers having a parallel orientation greater than 70%.

6. The body armor assembly of claim 5, wherein the parallel-oriented fibers of the one or more sheets forming the warp are oriented transverse to the parallel-oriented fibers of the strike plate sheets.

7. The body armor assembly of claim 1, wherein:
the wrap is placed on a side of the backing plate facing away from the strike plate;
the warp is wrapped over sides of the backing plate and strike plate; and
edges of the wrap terminate on a side of the strike plate facing away from the backing plate.

8. The body armor assembly of claim 1, further including a cover sheet covering the edges of the warp.

9. The body armor assembly of claim 8, wherein the cover sheet is formed of fibers having a parallel orientation greater than 70%.

10. A body armor plate comprising:
a strike plate formed of plural sheets layered on each other, each sheet of the strike plate formed of fibers having a parallel orientation greater than 70%, the plural sheets oriented such that the parallel-oriented fibers of all of the plural sheets are oriented or aligned in a single direction; and
a backing plate formed of a metal, or a metal alloy, or fibers that have a random orientation, wherein the backing plate and the strike plate are joined, or bonded, or cross-linked together.

11. The body armor plate of claim 10, wherein each strike plate sheet is formed of ultra-high-molecular-weight polyethylene (UHMWPE) fibers.

12. The body armor plate of claim 10, wherein the backing plate is formed of polyethylene thermoplastic fibers.

13. The body armor plate of claim 4, wherein the polyethylene thermoplastic fibers comprise high-density polyethylene (HDPE) or polyethylene high-density (PEHD).

14. A method of forming a body armor assembly comprising:
(a) providing a strike plate formed of plural sheets layered on each other, each sheet of the strike plate formed of fibers having a parallel orientation greater than 70%, the plural sheets oriented such that the parallel-oriented fibers of all of the plural sheets are oriented or aligned in a single direction;
(b) providing a backing plate formed of a metal, or a metal alloy, or fibers that have a random orientation; and
(c) joining, or bonding, or cross-linking the backing plate and the strike plate together.

15. The method of claim 14, wherein step (a) includes bonding the plural sheets of the strike plate together using heat and pressure.

16. The method of claim 14, wherein step (c) includes bonding the backing plate and the strike plate together using heat and pressure.

17. The method of claim 14, further including:
(d) following step (c), wrapping the backing plate and the strike plate with a warp.

18. The method of claim 17, wherein step (d) includes bonding the wrap to the backing plate, the strike plate, or both using heat and pressure.

19. The method of claim 17, wherein at least one of the following:
the strike plate sheets are formed of ultra-high-molecular-weight polyethylene (UHMWPE);
the backing plate is formed of high-density polyethylene (HDPE) or polyethylene high-density (PEHD) material; and
the warp is formed of UHMWPE.
